(19) United States
(12) Patent Application Publication
(10) Pub. No.: US 2023/0040887 A1
(43) Pub. Date: Feb. 9, 2023

(54) DETERGENT COMPOSITION

(71) Applicant: THREEBOND CO., LTD., Tokyo (JP)

(72) Inventors: Shogo HASHIMOTO, Tokyo (JP); Hiroaki ITO, Tokyo (JP); Manabu KIRINO, Tokyo (JP)

(21) Appl. No.: 17/758,996

(22) PCT Filed: Jan. 27, 2021
(86) PCT No.: PCT/JP2021/002866

§ 371 Date: Jul. 18, 2022

(30) Foreign Application Priority Data
Jan. 31, 2020 (JP) 2020-015401

(51) Int. Cl. C11D 7/50; C11D 7/30; C11D 17/00; C11D 11/00

(52) U.S. Cl. CPC C11D 7/5018; C11D 7/30; C11D 17/0043; C11D 11/0041

(57) ABSTRACT

A detergent composition has high detergency and reduced erosivity with respect to resins. The detergent composition contains the following component (A) and component (B) A mass ratio of the component (A) to the component (B) is expressed as component (A): component (B)=40:60 to 55:45:

component (A): 1-chloro-3,3,3-trifluoropropene

component (B): a hydrofluoroolefin of the following general formula:

CₙF₂ₙ₋₁—O—CₘH₂ₘ₊₁.

n is an integer of 5 to 10, and m is an integer of 1 to 5.

### TECHNICAL FIELD

The present invention relates to a detergent composition having non-flammability, suitable for cleaning contaminants caused by grease or the like on a surface containing metal and resin.

### BACKGROUND ART

JP 2017-200989 A (corresponding to US 2020/0017979 A) describes an invention relating to a fluorine-based, non-flammable detergent and discloses that the detergent contains 1-chloro-3,3,3-trifluoropropene. In JP 2017-200989 A, issues of invasiveness (erosivity) to resins such as rubbers and plastics and reduced transparency thereof are evaluated as challenges for the detergent. This is attributed to an observed tendency of 1-chloro-3, 3, 3-trifluoropropene to erode and dissolve resins such as rubbers and plastics due to its strong detergency. In JP 2017-200989 A, evaluations are carried out through immersing resins such as plate-like rubbers and plastics in a detergent because, in devices and parts where resins are combined with metals, the resins being used in a specific area put stress on that specific area, thus the area is eroded by the detergent and easily cracked first.

### SUMMARY OF INVENTION

However, even with the technique described in JP 2017-200989 A, it was difficult to achieve both high detergency and suppression of erosivity to resins. Thus, with a conventional detergent composition, it was difficult to prevent erosion and cracking or the like of resins exist in stressed areas of devices and parts where the resins are combined with metals and to exhibit high detergency. An object of the present invention is thus to provide a detergent composition having high detergency and reduced erosivity with respect to resins.

As a result of intensive studies to achieve the object, the present inventors have found a means related to the detergent composition and completed the present invention.

The summary of the present invention will be described below. The first embodiment of the present invention is a detergent composition containing the following component (A) and component (B) , wherein a mass ratio of the component (A) to the component (B) is expressed as component (A): component (B)=40:60 to 55:45:

component (A): 1-chloro-3,3,3-trifluoropropene

component (B): a hydrofluoroolefin of the following general formula:

CₙF₂ₙ₋₁—O—CₘH₂ₘ₊₁

wherein n is an integer of 5 to 10, and m is an integer of 1 to 5.

The second embodiment of the present invention is the detergent composition according to the first embodiment, containing, as a solvent, only the component (A) and the component (B).

The third embodiment of the present invention is the detergent composition according to the first or second embodiment, being free of hydrochlorofluorocarbons, hydrofluoroethers, hydrofluorocarbons, and perfluoropolyethers.

The fourth embodiment of the present invention is the detergent composition according to any one of the first to third embodiments, wherein the component (A) is cis-1-chloro-3,3,3-trifluoropropene.

The fifth embodiment of the present invention is a cleaning aerosol including a pressure-resistant container filled with the detergent composition according to any one of the first to fourth embodiments and a propellant.

The sixth embodiment of the present invention is a cleaning sprayer including a double-structured container having an inner bag inside, the inner bag being filled with the detergent composition according to any one of the first to fourth embodiments.

The seventh embodiment of the present invention is a method for cleaning a contaminant adhered to a contaminated part with the detergent composition according to any one of the first to fourth embodiments.

The eighth embodiment of the present invention is the method according to the seventh embodiment, wherein the contaminated part is a brake device.

### DESCRIPTION OF EMBODIMENTS

The present invention will be described below in detail. A component (A) that can be used in the present invention is 1-chloro-3,3,3-trifluoropropene, which is a chlorine-fluorine-based solvent and one of hydrochlorofluoroolefins. The hydrochlorofluoroolefins are also called HCFOs. The component (A) may be cis-1-chloro-3,3,3-trifluoropropene, trans-1-chloro-3,3,3-trifluoropropene, or a mixture thereof, but especially cis-1-chloro-3,3,3-trifluoropropene is preferred in consideration of detergency. The component (A) is a main component that exerts a cleaning action on contaminants. The boiling point of the component (A) is, for example, 30° C. to 100° C., preferably 30° C. to 90° C., and more preferably 30° C. to 50° C. It has good detergency at a boiling point of 30° C. to 100° C. Here, the notation “to” between numerical values is a notation including the upper limit value and the lower limit value.

The component (A) has a very small ozone depletion potential (ODP) , resulting in a reduced impact on the environment. The ozone depletion potential is a value used in comparison of the strength of ozone layer depletion calculated by dividing the total amount of ozone depletion per kg of each compound by the total amount of ozone depletion per kg of trichlorofluoromethane. The ozone layer depletion potential of the component (A) is preferably 20 or less, further preferably 10 or less, and most preferably 5 or less.

The component (A) has a very small global warming potential (GWP), resulting in a reduced impact on the environment. The global warming potential is an index that relatively indicates the effect of each greenhouse gas on global warming with respect to the effect of carbon dioxide after considering the duration of the effect. The global warming potential is preferably 10 or less, further preferably 7 or less, and most preferably 5 or less.

The component (A) preferably has a large kauri-butanol (KB) value, and the kauri-butanol value is an index that shows a grease saturation power of a sample. The larger the numerical value, the more grease can be dissolved by the sample. The measurement method includes pouring a certain amount of a solution of a kauri resin in butanol into a flask, placing the flask on printing type paper, dropping a sample into the flask, and expressing the number of milliliters of the sample when a piece of printing type becomes unreadable due to the occurrence of turbidity. In the present invention, excellent detergency for contaminants can be exerted when the KB value is 10 or more. The kauri-butanol (KB) value of the component (A) is preferably 10 or more, more preferably 20 or more, and most preferably 30 or more.

Specific examples of the component (A) include, but are not limited to, SOLVIA (registered trademark) (cis-1-chloro-3,3,3-trifluoropropene) manufactured by SOLVEX INC.

A component (B) that can be used in the present invention is a fluorine-based solvent having a specific structure and is also called a hydrofluoroolefin. Hereinafter, the hydrofluoroolefin is also referred to as HFO. The hydrofluoroolefin is a fluorine compound having an unsaturated bond in the molecule, and the component (B) is a hydrofluoroolefin having an ether group. Specifically, the component (B) is a compound having a structure of CₙF₂ₙ₋₁—O—CₘH₂ₘ₊₁, wherein n is an integer of 5 to 10, and m is an integer of 1 to 5. In consideration of erosivity with respect to resins such as plastic, the boiling point is preferably 80° C. or higher, more preferably 90° C. or higher, and most preferably 100° C. or higher.

Specific examples of the component (B) include, but are not limited to, Opteon (registered trademark) SF10 (C₇F₁₃OCH₃) manufactured by Chemours-Mitsui Fluoroproducts Co., Ltd.

In the detergent composition of the present invention, amass ratio of the component (A) to the component (B) is expressed as component (A) : component (B)=40:60 to 55:45. This makes it possible to achieve both detergency for contaminants such as oil and suppression of erosivity with respect to resins such as plastic.

The detergent composition of the present invention can have high detergency and suppress erosivity with respect to resins. Therefore, it is possible to exhibit high detergency for contaminants such as oil while suppressing erosion and cracking or the like of resins exist in the stressed areas of devices and parts where the resins are combined with metals.

In addition, the detergent composition preferably contains, as a solvent, only the component (A) and the component (B) to maintain high detergency and low erosivity.

The detergent composition of the present invention preferably does not contain any of hydrochlorofluorocarbons (HCFCs) such as AMOLEA (registered trademark) AS-300 (manufactured by AGC Inc.); hydrofluoroethers (HFEs) such as C₄F₉OCH₃ and C₄F₉OC₂H₅; hydrofluorocarbons (HFCs) such as C₅F₁₀H₂; and perfluoropolyethers (PFPEs) such as GALDEN (registered trademark) SV55 and SV135 (manufactured by SOLVAY). In this manner, high detergency and low erosivity can be maintained. It is also preferred from the viewpoint of reducing the environmental impact thereof.

Here, the hydrochlorofluorocarbons (HCFCs) are compounds in which a part of hydrogen atoms in a saturated hydrocarbon is substituted with a chlorine atom and a fluorine atom. The hydrofluoroethers (HFEs) are compounds in which a hydrogen atom in a saturated hydrocarbon is substituted with an ether group and a fluorine atom (herein, an alkyl ether group is commonly used as the ether group). The hydrofluorocarbons (HFCs) are compounds in which a part of hydrogen atoms in a saturated hydrocarbon is substituted with a fluorine atom. The perfluoropolyethers (PFPEs) are compounds in which all hydrogen atoms in a polyoxyalkylene compound are substituted with fluorine atoms.

Optional components other than the component (A) and the component (B) can be added to the detergent composition of the present invention as long as the characteristics of the present invention are not impaired. Examples of the components include, but are not limited to, surfactants, ultraviolet absorbers, antioxidants, chelating agents, rust inhibitors, fragrances, and solvents other than the component (A) and the component (B) (excluding the HCFCs, HFEs, HFCs, and PFPEs).

Methods of using the present invention include, but are not limited to, cleaning by, wiping with a waste cloth, brush, or the like; immersing; ultrasonic cleaning; spraying with an air spray or an air gun; and injecting with aerosol or the like.

The present invention also provides a cleaning aerosol including a pressure-resistant container filled with the detergent composition of the present invention and a propellant. The present invention also provides a cleaning sprayer including a double-structured container having an inner bag inside, the inner bag being filled with the detergent composition of the present invention. The cleaning sprayer is preferably a cleaning sprayer that is obtained by filling a container with the detergent composition of the present invention and a spraying agent as required, wherein the container includes a can and an inner bag inside the can, and introducing compressed air into a space between the inner bag and the can, and that injects the detergent composition by the compressed air pushing the inner bag. A known substance can be used as the propellant, and it may be selected from, but is not limited to, dimethyl ether (DME), carbon dioxide, liquefied petroleum gas (LPG), nitrogen, nitrous oxide, isobutane, haloalkyl, a hydrofluoroolefin other than the component (B), compressed air, and the like. The hydrofluoroolefin other than the component (B), carbon dioxide, and nitrogen are particularly suitable, and carbon dioxide is most preferred, from the viewpoints of easy availability, safety, environmental impact, and the like.

Examples of fields or applications to which the detergent composition of the present invention is applicable include, but are not limited to, cleaning such as industrial machines, transport vehicles, electrical and electronic equipment, and industrial parts. Particularly, the detergent composition of the present invention can be suitably used for cleaning transport vehicles such as automobiles and train cars.

In other words, the present invention provides a method for cleaning a contaminant adhered to a contaminated part with the detergent composition of the present invention. Examples of the contaminated parts include a brake device, especially a brake device of a transport vehicle, but the detergent composition of the present invention is also suitable for cleaning other machines. Particularly, it may be used for cleaning contaminated parts containing non-metallic materials such as resins, for example, polycarbonate and ABS, and fibers. Examples of the contaminants include grease and solids such as gear oil and brake fluid. In addition, the detergent composition of the present invention can be applied to applications other than cleaning which are required to dissolve grease and solids such as gear oil and brake fluid as contaminants, for example, removal of pressure-sensitive adhesives and adhesive agents. The detergent composition of the present invention can be used for cleaning areas contaminated by grease or the like on surfaces made of metal or resin.

### EXAMPLES

The present invention will be described below in more detail with reference to Examples, but the present invention is not limited only to these Examples. The detergent composition is also simply referred to as the composition.

### Examples 1 and 2 and Comparative Examples 1 to 20

For producing a detergent composition, the following components were prepared. Here, HCFO is an abbreviation for hydrochlorofluoroolefin; HCFC for hydrochlorofluorocarbon; HFO for hydrofluoroolefin; HFE for hydrofluoroether; HFC for hydrofluorocarbon; and PFPE for perfluoropolyether (no hydrogen).

Component (A): 1-chloro-3,3,3-trifluoropropene

cis-1-chloro-3,3,3-trifluoropropene (HCFO): SOLVIA (registered trademark) (boiling point: 39° C.) manufactured by SOLVEX INC.

Component (A′): a chlorine-fluorine-based solvent other than the component (A)

Hydrochlorofluorocarbon (HCFC): AMOLEA (registered trademark) AS-300 (boiling point: 54° C.) manufactured by AGC Inc.

Component (B): a specific hydrofluoroolefin

C₇F₁₃OCH₃ (HFO): Opteon (registered trademark) SF10 (boiling point: 110° C.) manufactured by Chemours-Mitsui Fluoroproducts Co., Ltd.

Component (B′): a fluorine-based solvent other than the component (B)

Hydrofluoroolefin HFO: DR CFX70 (boiling point: 71° C.) manufactured by Chemours-Mitsui Fluoroproducts Co., Ltd.

C₄F₉OCH₃ (HFE): Novec (registered trademark) 7100 (boiling point: 61° C.) manufactured by 3M Japan Limited

C₄F₉OC₂H₅ (HFE) : Novec (registered trademark) 7200 (boiling point: 76° C.) manufactured by 3M Japan Limited

C₅F₁₀H₂(HFC): Vertrel XF (boiling point: 55° C.) manufactured by Chemours-Mitsui Fluoroproducts Co., Ltd.

Perfluoropolyether (PFPE): GALDEN (registered trademark) SV55 (boiling point: 55° C.) manufactured by SOLVAY

Perfluoropolyether (PFPE): GALDEN (registered trademark) SV135 (boiling point: 135° C.) manufactured by SOLVAY

The component (A) (or the component (A′)) and the component (B) (or component (B′)) were weighed in a beaker and stirred by a motor with stirring blades for 10 minutes. Detailed preparation amounts are given according to Table 1, and all numerical values are expressed in parts by mass.

TABLE 1

| | | | | Com- | Com- | Com- | Com- | Com- | Com- | Com- | Com- | Com- |
|---|---|---|---|---|---|---|---|---|---|---|---|---|
| | | | | parative | parative | parative | parative | parative | parative | parative | parative | parative |
| Com- | Raw | Exam- | Exam- | Exam- | Exam- | Exam- | Exam- | Exam- | Exam- | Exam- | Exam- | Exam- |
| ponent | material | ple 1 | ple 2 | ple 1 | ple 2 | ple 3 | ple 4 | ple 5 | ple 6 | ple 7 | ple 8 | ple 9 |
| Com- | SOLVIA | 40 | 55 | 10 | | 10 | 10 | 10 | 10 | 10 | 10 | 40 |
| ponent (A) | | | | | | | | | | | | |
| Com- | AS-300 | | | | 10 | | | | | | | |
| ponent (A′) | | | | | | | | | | | | |
| Com- | SF10 | 60 | 45 | 90 | 90 | | | | | | | |
| ponent (B) | | | | | | | | | | | | |
| Com- | CFX70 | | | | | 90 | | | | | | 60 |
| ponent (B′) | 7100 | | | | | | | | | 90 | | |
| | 7200 | | | | | | | | | | 90 | |
| | XF | | | | | | 90 | | | | | |
| | SV55 | | | | | | | 90 | | | | |
| | SV135 | | | | | | | | 90 | | | |
| Total | | 100 | 100 | 100 | 100 | 100 | 100 | 100 | 100 | 100 | 100 | 100 |
| | | Com- | Com- | Com- | Com- | Com- | Com- | Com- | Com- | Com- | Com- | Com- |
| | | parative | parative | parative | parative | parative | parative | parative | parative | parative | parative | parative |
| Com- | Raw | Exam- | Exam- | Exam- | Exam- | Exam- | Exam- | Exam- | Exam- | Exam- | Exam- | Exam- |
| ponent | material | ple 10 | ple 11 | ple 12 | ple 13 | ple 14 | ple 15 | ple 16 | ple 17 | ple 18 | ple 19 | ple 20 |
| Com- | SOLVIA | 40 | 40 | 40 | 40 | 40 | 60 | 30 | 5 | | | 60 |
| ponent (A) | | | | | | | | | | | | |
| Com- | AS-300 | | | | | | | | | 40 | 30 | |
| ponent (A′) | | | | | | | | | | | | |
| Com- | SF10 | | | | | | 40 | 70 | 95 | 60 | 70 | |
| ponent (B) | | | | | | | | | | | | |
| Com- | CFX70 | | | | | | | | | | | 40 |
| ponent (B′) | 7100 | | | | 60 | | | | | | | |
| | 7200 | | | | | 60 | | | | | | |
| | XF | 60 | | | | | | | | | | |
| | SV55 | | 60 | | | | | | | | | |
| | SV135 | | | 60 | | | | | | | | |

| | | | | | | | | | | | |
|---|---|---|---|---|---|---|---|---|---|---|---|
| Total | 100 | 100 | 100 | 100 | 100 | 100 | 100 | 100 | 100 | 100 | 100 |

Erosivity confirmation test and detergency confirmation test were conducted for each detergent composition prepared in Examples 1 and 2 and Comparative Examples 1 to 20.

[Erosivity Confirmation Test]

A test piece was made by drilling a hole having a diameter of 6 mm in the center of a 25 mm long x 100 mm long x 2 mm thick resin plate, followed by fastening an M6 bolt and nut with a tightening torque of 6N. The detergent composition was placed in a glass bottle, the test piece was immersed therein and allowed to stand for a specific period of time with the lid closed, and “erosivity” was evaluated based on the occurrence of cracks and surface dissolution by visual confirmation in accordance with the following evaluation criteria. Here, the surface dissolution means that the surface of the test piece becomes cloudy. Polycarbonate resin (Panlite (registered trademark) L-1225Y manufactured by TEIJIN LIMITED) and acrylonitrile-butadiene-styrene (ABS) resin (ABS-N-WN manufactured by Showa Denko Materials Co., Ltd.) were used as the resin plate type. To reduce erosivity, it is preferable that the two resins both be rated “Excellent.”

Evaluation Criteria

Excellent: No cracks and no surface dissolution occurred after 6 hours or longer of immersion

Good: Cracks or surface dissolution occurred after 10 minutes or longer and less than 6 hours of immersion

Fair: Cracks or surface dissolution occurred after 1 minute or longer and less than 10 minutes of immersion

Poor: Cracks or surface dissolution occurred immediately after immersion or after less than 1 minute of immersion.

[Detergency Confirmation Test]

After 1 g of oil was placed in a glass bottle, 50 ml of the detergent composition was added thereto, and the bottle was closed with the lid. The glass bottle was shaken by hand for 10 seconds and then allowed to stand for 5 minutes, and its detergency was visually determined in accordance with the following evaluation criteria. Gear oil (GL-3 75W-90 manufactured by CASTROL LIMITED) and brake fluid (DOT3 manufactured by Toyota Motor Corporation) were used as the oil type. To achieve both erosivity and detergency, it is preferable that the two oils both be rated “Good. ” Here, the detergency indicates not only dissolving the oil but also floating and emulsifying the oil.

Evaluation Criteria

Good: Oil is completely emulsified or dissolved

Fair: Residues of unemulsified oil are present

Poor: The composition is separated from the oil.

TABLE 2

| | | | | Com- | Com- | Com- | Com- | Com- | Com- | Com- | Com- | Com- |
|---|---|---|---|---|---|---|---|---|---|---|---|---|
| | | | | parative | parative | parative | parative | parative | parative | parative | parative | parative |
| Test | | Exam- | Exam- | Exam- | Exam- | Exam- | Exam- | Exam- | Exam- | Exam- | Exam- | Exam- |
| item | Subject | ple 1 | ple 2 | ple 1 | ple 2 | ple 3 | ple 4 | ple 5 | ple 6 | ple 7 | ple 8 | ple 9 |
| Erosivity | Poly- | Excel- | Excel- | Excel- | Excel- | Excel- | Excel- | Excel- | Excel- | Excel- | Excel- | Good |
| | carbonate | lent | lent | lent | lent | lent | lent | lent | lent | lent | lent | |
| | ABS | Excel- | Excel- | Excel- | Excel- | Excel- | Excel- | Excel- | Excel- | Excel- | Excel- | Good |
| | | lent | lent | lent | lent | lent | lent | lent | lent | lent | lent | |
| Deter- | Gear oil | Good | Good | Fair | Fair | Fair | Fair | Fair | Fair | Fair | Fair | Good |
| gency | Brake fluid | Good | Good | Good | Good | Good | Good | Good | Good | Good | Good | Good |
| | | Com- | Com- | Com- | Com- | Com- | Com- | Com- | Com- | Com- | Com- | Com- |
| | | parative | parative | parative | parative | parative | parative | parative | parative | parative | parative | parative |
| Test | | Exam- | Exam- | Exam- | Exam- | Exam- | Exam- | Exam- | Exam- | Exam- | Exam- | Exam- |
| item | Subject | ple 10 | ple 11 | ple 12 | ple 13 | ple 14 | ple 15 | ple 16 | ple 17 | ple 18 | ple 19 | ple 20 |
| Erosivity | Poly- | Good | Good | Good | Good | Good | Good | Excellent | Excellent | Poor | Poor | Good |
| | carbonate | | | | | | | | | | | |
| | ABS | Good | Good | Good | Good | Good | Good | Excellent | Excellent | Poor | Poor | Good |
| Deter- | Gear oil | Good | Good | Good | Good | Good | Good | Poor | Poor | Good | Poor | Good |
| gency | Brake fluid | Good | Good | Good | Good | Good | Good | Good | Poor | Good | Good | Good |

In Examples 1 and 2, the erosivity is “Excellent” for both of the two resins, and the detergency is “Good” for both of the two oils. On the other hand, in Comparative Examples 1 to 8, the detergency is low for one oil, and in Comparative Examples 9 to 15 and 20, no “Excellent” is exhibited for the erosivity. In Comparative Examples 16 to 19, “Poor” is exhibited for erosivity or detergency. Specifically, the detergency is insufficient when the prescribed component (A) is not used, or when the mass ratio of the prescribed component (A) is smaller than the prescribed value even if it is used, as in Comparative Examples 1 to 8. In addition, the erosivity cannot be sufficiently reduced when the prescribed component (B) is not used, or when the mass ratio of the prescribed component (B) is smaller than the prescribed value even if it is used, as in Comparative Examples 9 to 15 and 20. Furthermore, both low erosivity and high detergency cannot be achieved when the mass ratio of the component (A) to the component (B) is outside of the prescribed range, or when the prescribed component (A) and component (B) are not used, as in Comparative Examples 16 to 19. Accordingly, the inclusion of the specific component (A) and component (B) in specific mass ratios makes it possible to achieve both erosivity and detergency in Examples 1 and 2.

### INDUSTRIAL APPLICABILITY

The detergent composition of the present invention can be used in various fields and applications since it can clean grease or solids adhered to contaminated parts of industrial machine parts, transport equipment parts, electrical and electronic parts, civil engineering, construction, and structural materials, containing metals and resins such as plastics, without erosion of the resins such as plastics and is environmentally friendly as well as non-flammable.

The present application is based on Japanese Patent Application No. 2020-015401 filed on Jan. 31, 2020, the entire disclosure of which is incorporated herein by reference.

1. A detergent composition comprising the following component (A) and component (B), wherein a mass ratio of the component (A) to the component (B) is expressed as component (A): component (B)=40:60 to 55:45:
component (A): 1-chloro-3,3,3-trifluoropropene
component (B): a hydrofluoroolefin of the following general formula:
CₙF₂ₙ₋₁—O—CₘH₂ₘ₊₁
wherein n is an integer of 5 to 10, and m is an integer of 1 to 5.

2. The detergent composition according to claim 1, comprising, as a solvent, only the component (A) and the component (B).

3. The detergent composition according to claim 1, being free of hydrochlorofluorocarbons, hydrofluoroethers, hydrofluorocarbons, and perfluoropolyethers.

4. The detergent composition according to claim 1, wherein the component (A) is cis-1-chloro-3,3,3-trifluoropropene.

5. A cleaning aerosol comprising a pressure-resistant container filled with the detergent composition according to claim 1 and a propellant selected from the group consisting of carbon dioxide and nitrogen.

6. A cleaning sprayer comprising a double-structured container having an inner bag inside, the inner bag being filled with the detergent composition according to claim 1.

7. A method for cleaning a contaminant adhered to a contaminated part with the detergent composition according to claim 1.

8. The method according to claim 7, wherein the contaminated part is a brake device.
